(19) United States
(12) Patent Application Publication
(10) Pub. No.: US 2012/0206400 A1
(43) Pub. Date: Aug. 16, 2012

(54) TOUCH PANEL OPERATION APPARATUS AND METHOD THEREOF

(75) Inventors: Yi-Ping Hung, Taipei (TW); Neng-Hao Yu, Taipei (TW); Yen-Yang Chen, Taipei (TW); Li-Wei Chan, New Taipei City (TW); Seng-Yong Lau, Taipei (TW); Sung-Sheng Tsai, Taipei (TW)

(73) Assignee: NATIONAL TAIWAN UNIVERSITY, Taipei (TW)

(21) Appl. No.: 13/251,296

(22) Filed: Oct. 3, 2011

(30) Foreign Application Priority Data
Feb. 16, 2011 (TW) 100105108

(51) Int. Cl. G06F 3/045

(52) U.S. Cl. 345/174

(57) ABSTRACT

A touch panel operation apparatus and a method thereof is provided. The touch panel operation apparatus includes a controller and a touch panel module. The controller generates a simulated figure touch signal and adds spatial static points on a tangible object, and the touch panel module detects the simulated figure touch signal and spatial distribution of the static points to identify the tangible object.

### CROSS-REFERENCE TO RELATED APPLICATION

This application claims the priority benefit of Taiwan application serial no. 100105108, filed Feb. 16, 2011. The entirety of the above-mentioned patent application is hereby incorporated by reference herein and made a part of this specification.

### BACKGROUND OF THE INVENTION

1. Field of the Invention

The invention relates to a touch panel operation apparatus and a method thereof. Particularly, the invention relates to a touch panel operation apparatus for detecting a tangible object and a method thereof.

2. Description of Related Art

Tangible object-controlled user interfaces have been developed for many years in development of human-machine interfaces and have a plenty of commercial applications. A conventional tangible object detection technique is generally applied to a large-scale desktop system, and uses a video camera to take a picture of an object for tracing a position of the object and identifying the object.

In recent years, a capacitive multi-touch technique has become a mainstream in the market. However, in development of a conventional capacitive touch panel technique, it is mainly focused on tracing finger moving tracks and click signals, and is lack of a related function for identifying a tangible object. Today, as touch panels and flat panel computers are widely used, demands for such type of electronic products are gradually increased, especially in a domain of game industry, if the function of detecting the tangible object is added to the capacitive touch panel to enable the capacitive touch panel to identify an object disposed thereon, in a two-player or multi-player game, a tangible object can be used to represents the user to interact with other game players. In this way, a usage scope of the capacitive touch panel is greatly expanded.

### SUMMARY OF THE INVENTION

An exemplary embodiment of the invention provides a touch panel operation apparatus including a controller and a touch panel module. The controller generates a simulated finger touch signal on a tangible object, and the touch panel module detects a frequency of the simulated finger touch signal to identify the tangible object.

An exemplary embodiment of the invention provides a touch panel operation method, which includes generating a simulated finger touch signal on a tangible object, and detecting a frequency of the simulated finger touch signal to identify the tangible object.

An exemplary embodiment of the invention provides a touch panel operation method, which includes detecting a frequency of a simulated finger touch signal to identify whether a tangible object is a correct unlocking object, and releasing a locking state of a touch panel module when it is determined that the tangible object is the correct unlocking object.

An exemplary embodiment of the invention provides a touch panel operation apparatus including a controller, a static point module and a touch panel module. The controller generates a simulated finger touch signal on a tangible object. The static point module is disposed at the bottom of the tangible object, and is made of a conductive material. The touch panel module detects a frequency of the simulated finger touch signal and spatial distribution of the static point module to identify the tangible object.

An exemplary embodiment of the invention provides a touch panel operation method, which includes generating a simulated finger touch signal on a tangible object, and configuring a static point module made of a conductive material at the bottom of the tangible object, and detecting a frequency of the simulated finger touch signal and spatial distribution of the static point module to identify the tangible object. An exemplary embodiment of the invention provides a touch panel operation method, which includes detecting a frequency of a simulated finger touch signal and spatial distribution of a static point module to identify whether a tangible object is a correct unlocking object, and releasing a locking state of a touch panel module when it is determined that the tangible object is the correct unlocking object.

An exemplary embodiment of the invention provides a touch panel operation apparatus including a touch panel module, a conduction unit and a controller. The touch panel module detects whether a panel touch key receives a touch signal, and executes a function corresponding to the panel touch key. A first connection terminal of the conduction unit is disposed at the panel touch key of the touch panel module, and the controller is coupled to a second connection terminal of the conduction unit, and transmits the touch signal generated by the controller to the panel touch key through the conduction unit.

An exemplary embodiment of the invention provides a touch panel operation method, which includes using a conduction unit to transmit a touch signal of a controller to a panel touch key, and detecting whether the panel touch key receives the touch signal, and executing a function corresponding to the panel touch key.

According to the above descriptions, the invention provides a touch panel operation apparatus and a method thereof. The touch panel operation method includes generating a simulated finger touch signal on a tangible object, and detecting a frequency of the simulated finger touch signal to identify the tangible object. In this way, only a simple frequency oscillation circuit is used to simulate a finger touch signal of the user on the touch panel, and the tangible object can be identified according to different oscillation frequencies. The technical feature of the invention can also be used to an unlocking technique, and the oscillation frequency is used to identify whether the tangible object is a correct unlocking object, so as to determine whether or not to perform an unlocking operation. Moreover, by adding a conduction unit without increasing circuits and requiring a power supply, operations of the touch panel can be diversified, and the operation of the touch panel key can be adjusted at any time according to user's requirement by using the externally connected conduction unit.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a configuration of a touch panel operation apparatus according to a first exemplary embodiment of the invention.

FIG. 1B is a functional block diagram of a touch panel operation apparatus according to the first exemplary embodiment of the invention.

FIG. 2 is a flowchart illustrating a touch panel operation method according to the first exemplary embodiment of the invention.

FIG. 3 is a flowchart illustrating a touch panel operation method according to the first exemplary embodiment of the invention.

FIG. 4A is a schematic diagram of a configuration of a touch panel operation apparatus according to a second exemplary embodiment of the invention.

FIG. 4B is a functional block diagram of a touch panel operation apparatus according to the second exemplary embodiment of the invention.

FIG. 4C is a functional block diagram of a touch panel operation apparatus according to the second exemplary embodiment of the invention.

FIG. 5A is a flowchart illustrating a touch panel operation method according to the second exemplary embodiment of the invention.

FIG. 5B is a flowchart illustrating another touch panel operation method according to the second exemplary embodiment of the invention.

FIG. 6 is a functional block diagram of a touch panel operation apparatus according to a third exemplary embodiment of the invention.

FIG. 7 is a flowchart illustrating a touch panel operation method according to the third exemplary embodiment of the invention.

FIG. 8A is an operational schematic diagram of a touch panel operation apparatus according to a first exemplary embodiment of the invention.

FIG. 8B is a schematic diagram illustrating pulses of an oscillation circuit element according to the first exemplary embodiment of the invention.

FIG. 8C is a schematic diagram of a touch panel operation apparatus according to the first exemplary embodiment of the invention.

FIG. 9A and FIG. 9B are operational schematic diagrams of another touch panel operation apparatus according to the first exemplary embodiment of the invention.

FIG. 10A and FIG. 10B are operational schematic diagrams of another touch panel operation apparatus according to the second exemplary embodiment of the invention.

FIGS. 11A-11E are operational schematic diagrams of a touch panel operation apparatus according to a third exemplary embodiment of the invention.

### DETAILED DESCRIPTION OF DISCLOSED EMBODIMENTS

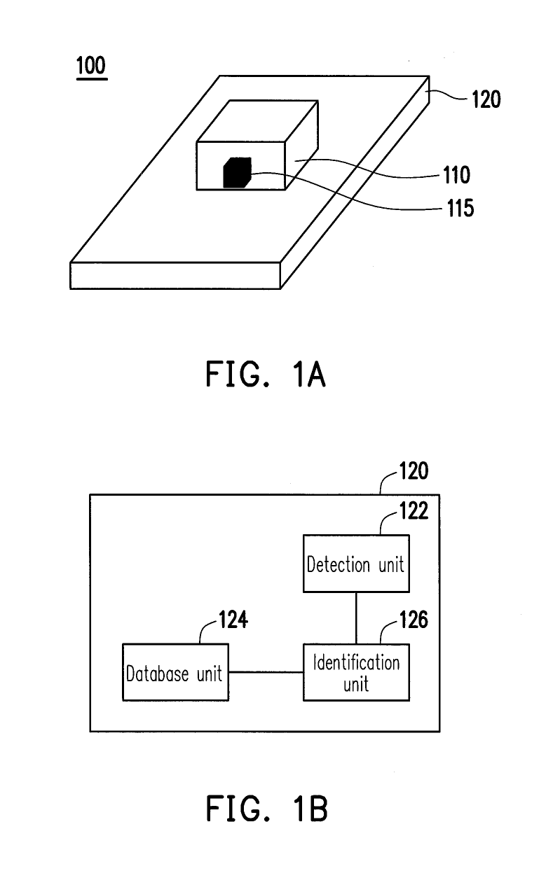

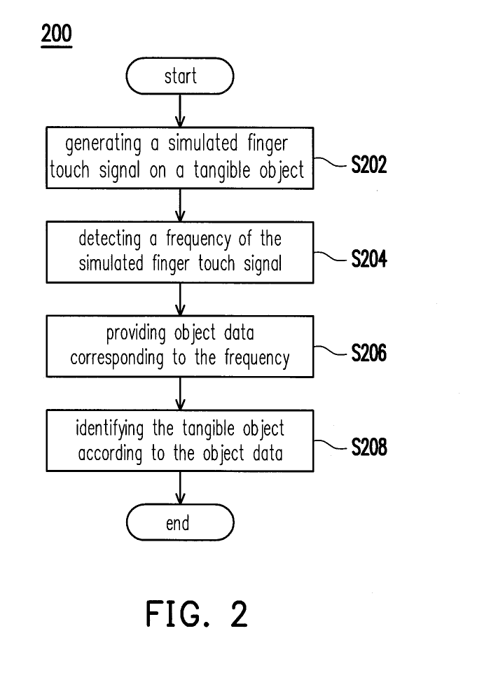

FIG. 1A is a schematic diagram of a configuration of a touch panel operation apparatus 100 according to a first exemplary embodiment of the invention. FIG. 1B is a functional block diagram of the touch panel operation apparatus 100 according to the first exemplary embodiment of the invention. FIG. 2 is a flowchart illustrating a touch panel operation method 200 according to the first exemplary embodiment of the invention. Referring to FIG. 1A, FIG. 1B and FIG. 2, a controller 115 can be attached to a tangible object 110 to generate a simulated finger touch signal (step S202), and a frequency of the simulated finger touch signal can be arbitrarily adjusted by a user. A touch panel module 120 includes a detection unit 122, a database unit 124 and an identification unit 126. The detection unit 122 of the touch panel module detects the frequency of the simulated finger touch signal (step S204), and the database unit 124 provides object data corresponding to the frequency (step S206), the identification unit 126 is coupled to the detection unit 122 and the database unit 124, and identifies the tangible object according to the object data (step S208).

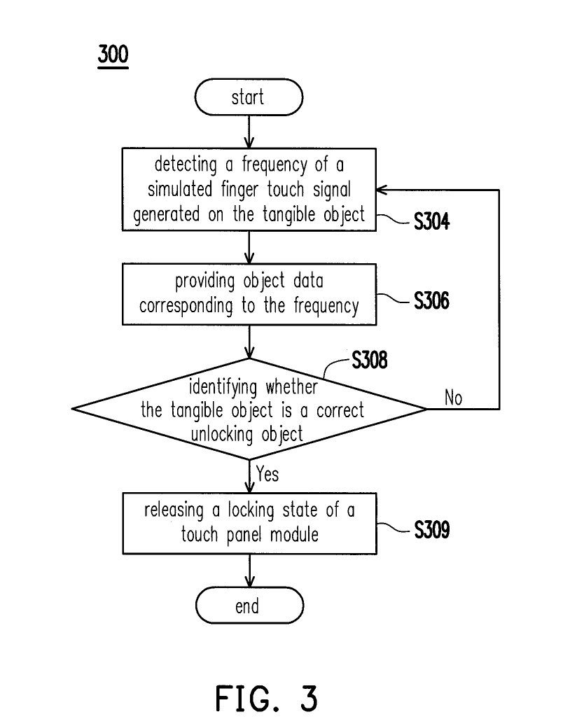

FIG. 3 is a flowchart illustrating a touch panel operation method 300 according to the first exemplary embodiment of the invention. An apparatus configuration and a functional block diagram for implementing the touch panel operation method 300 are similar as that shown in FIG. 1A and FIG. 1B. Referring to FIG. 1A, FIG. 1B and FIG. 3. First, the detection unit 122 is used to detect a frequency of a simulated finger touch signal generated by the controller 115 on the tangible object 110 (step S304), and then the database unit 124 provides object data corresponding to the frequency (step S306). Then, the identification unit 126 identifies whether the tangible object 110 is a correct unlocking object according to the object data (step S308), and if yes, a locking state of the touch panel module 120 is released (step S309), and if not, the frequency of the simulated finger touch signal is continually detected (step S304).

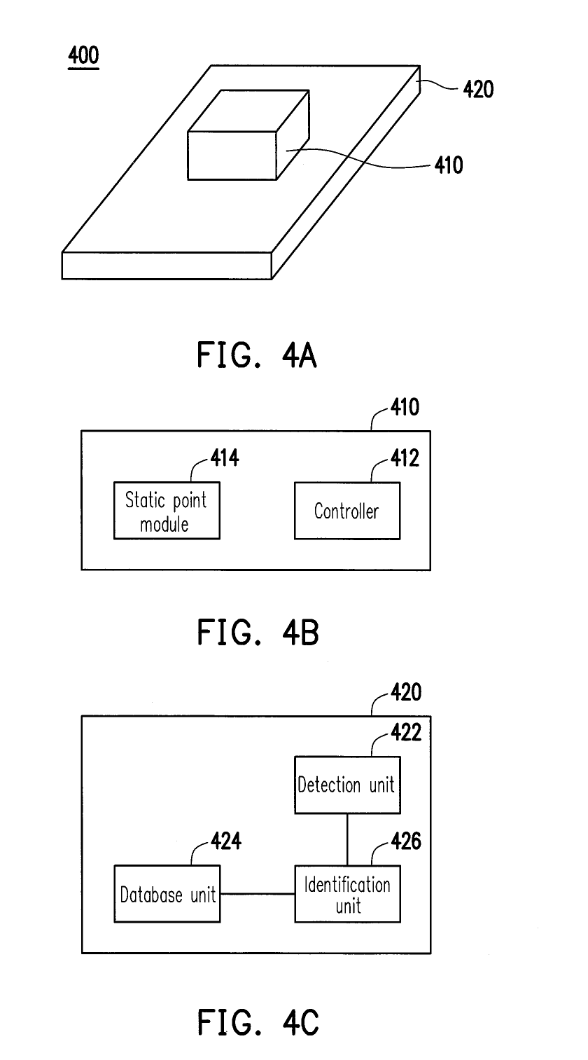

FIG. 4A is a schematic diagram of a configuration of a touch panel operation apparatus 400 according to a second exemplary embodiment of the invention. FIG. 4B is a functional block diagram of the touch panel operation apparatus 400 according to the second exemplary embodiment of the invention. FIG. 4C is a functional block diagram of the touch panel operation apparatus 400 according to the second exemplary embodiment of the invention.

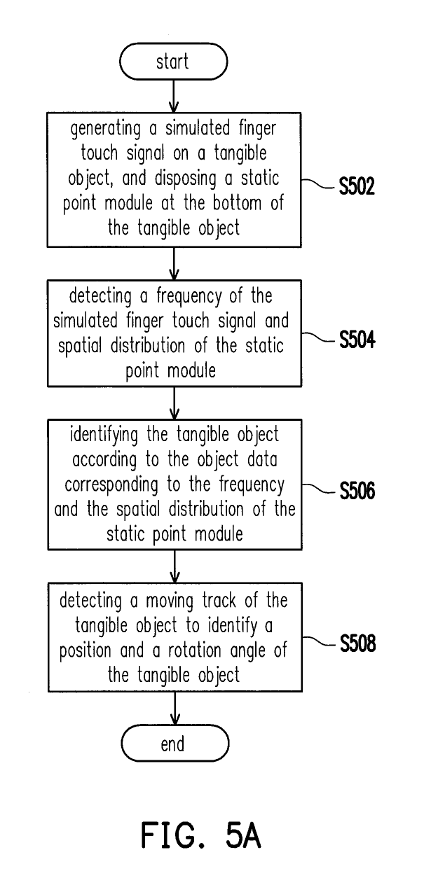

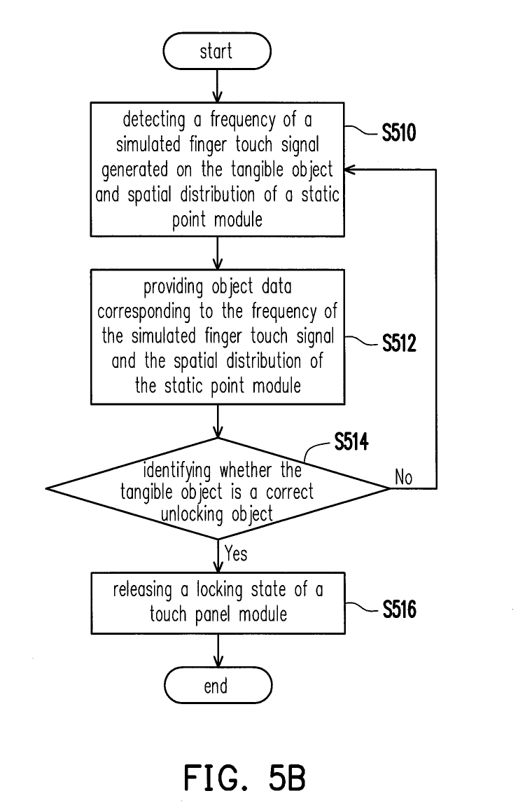

FIG. 5A is a flowchart illustrating a touch panel operation method according to the second exemplary embodiment of the invention. Referring to FIG. 4A, FIG. 4B, FIG. 4C and FIG. 5A. First, a controller 412 is attached on a tangible object 410, the controller 412 generates a simulated finger touch signal, and a static point module 414 is disposed at the bottom of the tangible object 410 (step S502), where the frequency of the simulated finger touch signal can be arbitrarily adjusted by the user, and the static point module 414 disposed at the bottom of the tangible object 410 and made of a conductive material moves or rotates along with the tangible object 410 to produce a track signal. A detection unit 422 in a touch panel module 420 detects the frequency of the simulated finger touch signal and spatial distribution of the static point module 414 (step S504), and a database unit 424 provides object data corresponding to the frequency of the simulated finger touch signal and the spatial distribution of the static point module 414. An identification unit 426 is coupled to the detection unit 422 and the database unit 424. The identification unit 426 identifies the tangible object 410 according to the object data (step S506), and detects the track signal generated according to a moving track of the tangible object 410 to identify a position and a rotation angle of the tangible object 410 (step S508), where the step S508 can be omitted in another embodiment.

FIG. 5B is a flowchart illustrating another touch panel operation method according to the second exemplary embodiment of the invention. Referring to FIG. 4A, FIG. 4B, FIG. 4C and FIG. 5B, the frequency of the simulated finger touch signal generated on the tangible object 410 and the spatial distribution of the static point module 414 are detected (step S510). The database unit 424 provides the object data corresponding to the frequency of the simulated finger touch signal and the spatial distribution of the static point module 414 (step S512), and it is determined whether the tangible object 410 is a correct unlocking object according to the object data (step S514), and if yes, the locking state of the touch panel module 420 is released (step S516), and if not, the step 5510 is returned to continue the detection.

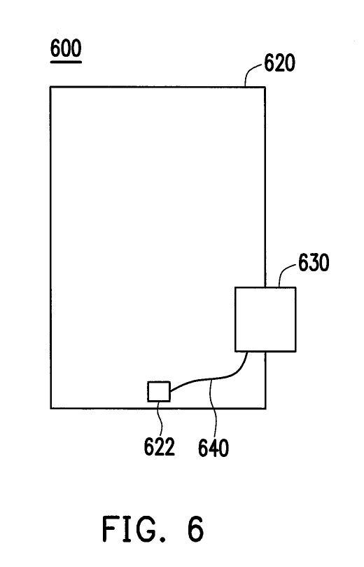

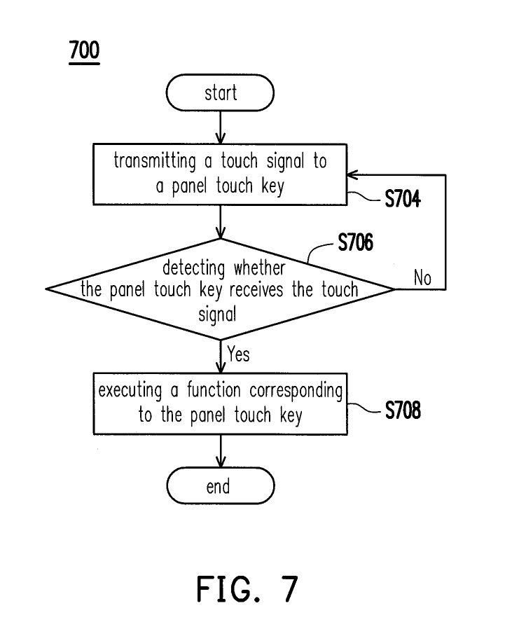

FIG. 6 is a functional block diagram of a touch panel operation apparatus 600 according to a third exemplary embodiment of the invention. FIG. 7 is a flowchart illustrating a touch panel operation method 700 according to the third exemplary embodiment of the invention. Referring to FIG. 6 and FIG. 7, first, a controller 630 is provided to the user to perform a click operation to generate a touch signal, and then a conduction unit 640 made of a conductive material is connected to the controller 630 and a panel touch key 622, and the touch signal is transmitted to the panel touch key 622 through the conduction unit 640 (step S704). A touch panel module 620 detects whether the panel touch key 622 receives the touch signal (step S706), and if yes, the touch panel module 620 executes a function corresponding to the panel touch key 622, and if not, the step S704 is returned.

To fully convey the spirit of the invention to those skilled in the art, a plurality of practical embodiments are provided below for detail descriptions.

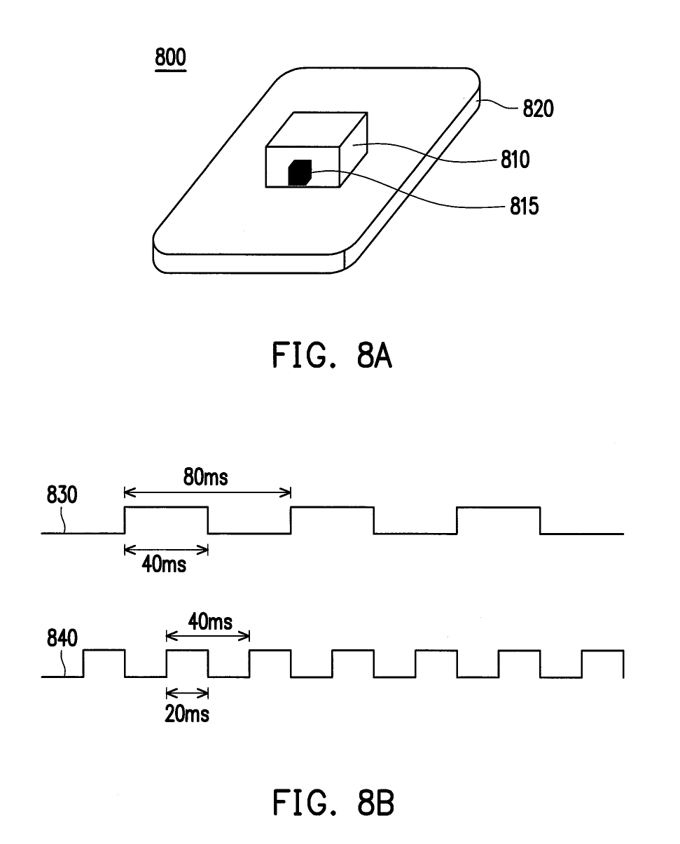

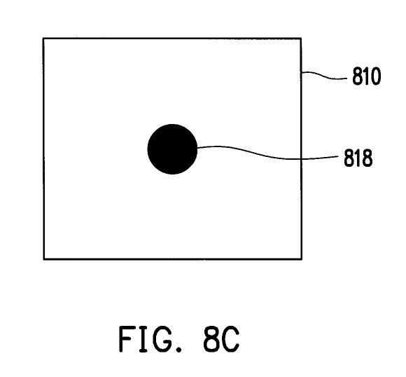

FIG. 8A is an operational schematic diagram of a touch panel operation apparatus 800 according to a first exemplary embodiment of the invention. FIG. 8B is a schematic diagram illustrating pulses of an oscillation circuit element according to the first exemplary embodiment of the invention. Referring to FIG. 8A, FIG. 8B and FIG. 8C, a touch panel module 820 of the embodiment can be applied for character identification in a game domain. A character block 810 has an oscillation circuit element 815, and the bottom of the character block 810 has a contact point 818, the contact point 818 contacts the touch panel module 820 for electrical conduction. The touch panel module 820 detects a frequency through the touch point 818. The operation that the user's finger quickly clicks a touch surface of the touch panel module 820 is simulated by turning on/off the circuit, and an oscillation frequency of the oscillation circuit element 815 simulates a speed that the user clicks the touch surface of the touch panel module 820. Moreover, the oscillation frequency of the oscillation circuit element 815 can be arbitrarily adjusted by the user, and in case of a different frequency, the touch panel module 820 identifies the character block 810 as a different character. In other words, only one character block 810 is used, and by adjusting the oscillation frequency of the oscillation circuit element 815, for example, adjusting a pulse cycle of a first oscillation frequency 830 to 80 ms, or adjusting a pulse cycle of a second oscillation frequency 840 to 40 ms, the touch panel module 820 can detect the oscillation frequencies of the two touch signals, and identifies the character block 810 as two different characters.

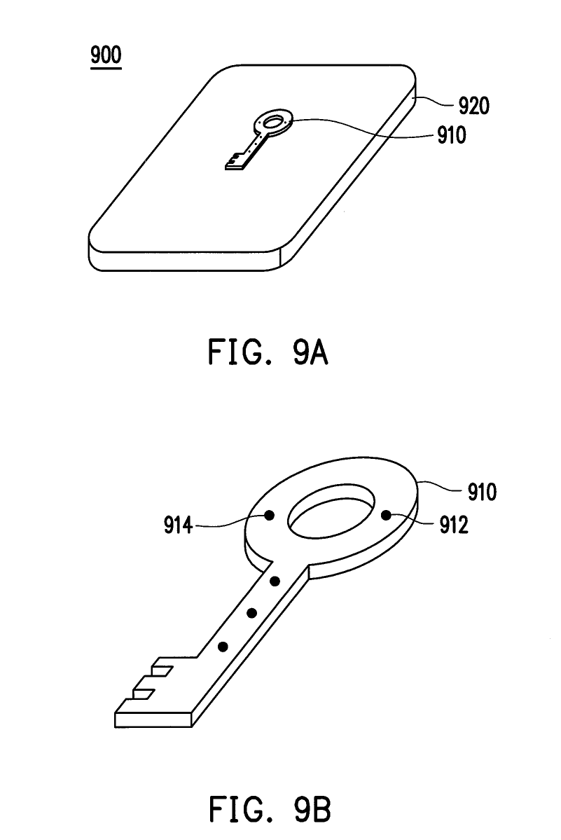

FIG. 9A and FIG. 9B are operational schematic diagrams of a touch panel operation apparatus 900 according to the first exemplary embodiment of the invention. The technical features of the invention can also be applied for unlocking the computer system. Generally, regarding a computer booting system or a screen saver unlocking program, the user generally inputs a password for unlocking, but in some cases, for example, in public places fully of people, it is not suitable to input the password, and according to the technical feature of the invention, a key 910 can be used to implement the unlock operation.

First, the user presets an oscillation frequency of a simulated finger touch signal capable of executing unlocking on a touch panel module 920, and then sets a first oscillation frequency controller 912 and a second oscillation frequency controller 914 on the key 910 to an oscillation frequency capable of executing unlocking. In this way, the user can use the key 910 to touch the touch surface of the touch panel module 920 for unlocking. An advantage of such application is that when it is inconvenient to input the password, the user can use the key 910 for unlocking. Moreover, the predetermined unlocking oscillation frequency of the system can be arbitrarily adjusted, and the key 910 can be used to conveniently perform unlocking as the oscillation frequency of the system is adjusted. The oscillation frequency controllers of the key 910 can be plural, for example, each oscillation frequency controller has seven adjustable frequencies, and the key 910 has five oscillation frequency controllers. Such unlocking mechanism has 16807 variations available for the user to adjust at any time.

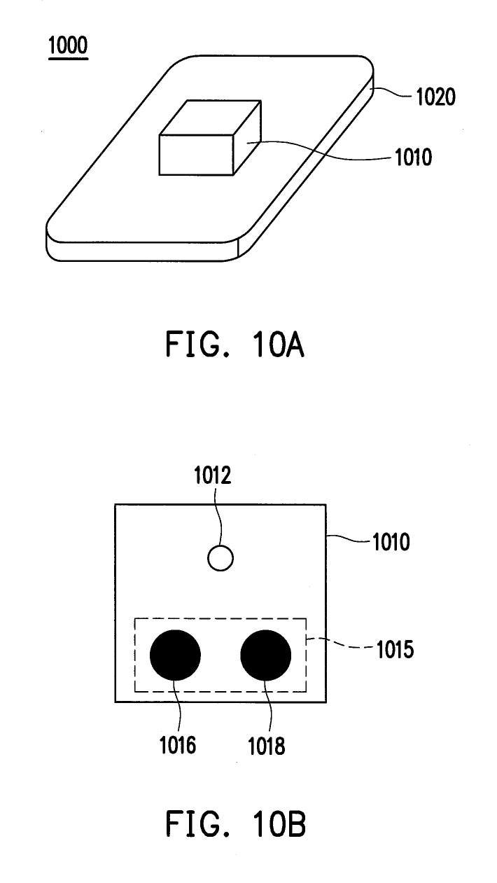

FIG. 10A and FIG. 10B are operational schematic diagrams of a touch panel operation apparatus 1000 according to the second exemplary embodiment of the invention. In the present embodiment, besides the function of identifying the tangible object of FIG. 8A and FIG. 8B is implemented, a moving track and a rotation angle of the tangible object can be simultaneously obtained. The present embodiment can also be applied in the game domain, and besides that a character block 1010 uses an oscillation circuit element 1012 to generate the simulated finger touch signal for providing to a touch panel module 1020 for detection and identification, electrical conduction relations between a first static point 1016 and a second static point 1018 in a static point module 1015 and the touch surface of the touch panel module 1020 can also be used to detect the moving track and the rotation angle of the tangible object.

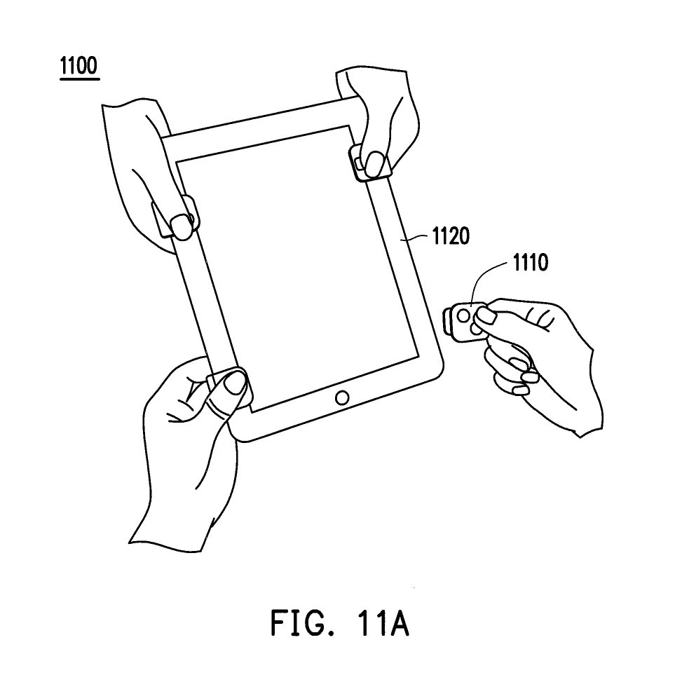

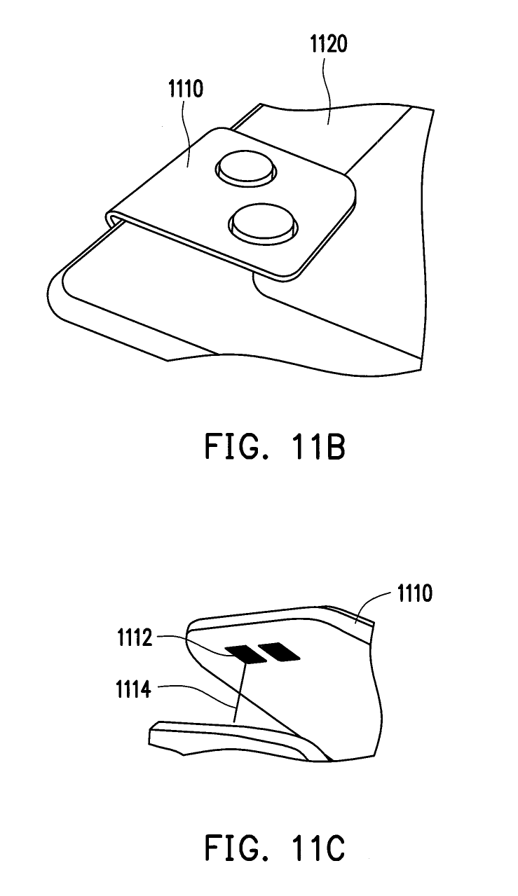

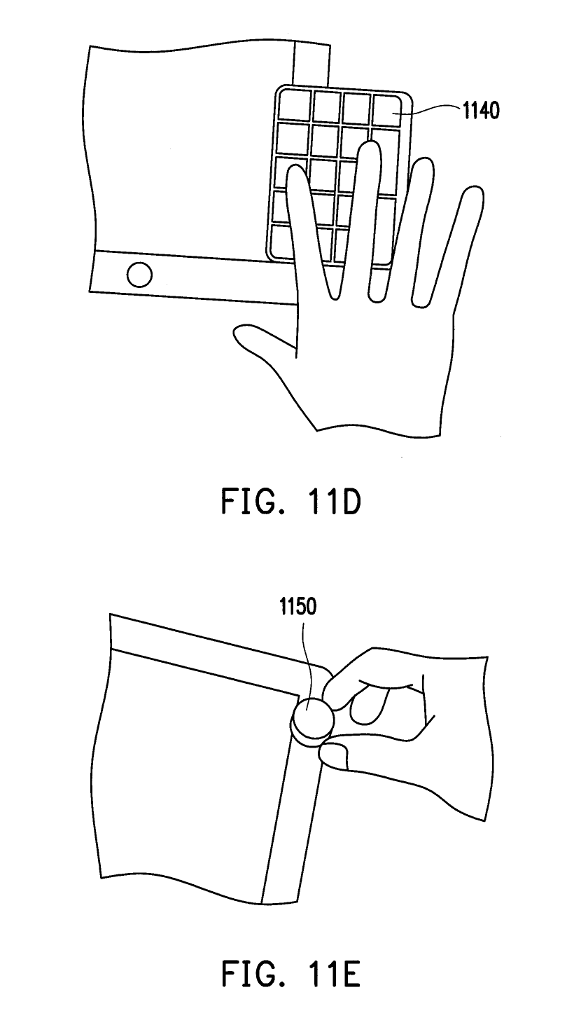

FIGS. 11A-11E are operational schematic diagrams of a touch panel operation apparatus according to a third exemplary embodiment of the invention. Referring to FIGS. 11A-11C, the present embodiment can be applied in the game domain, and the user can control an operation of a touch panel module 1120 by pressing a clip-type controller 1110. A conduction unit of the present embodiment includes a conductive rubber 1112 and a wire 1114, and a touch signal generated by a press operation of the user is transmitted to the touch panel module 1120 through the conductive rubber 1112 and the wire 1114, and according to a configuration of a connection terminal of the wire 1114, the touch panel module 1120 executes a function corresponding to the panel touch key connected to the connection terminal. FIG. 11D illustrates another embodiment of the invention, in which the clip-type controller 1110 is replaced by a keyboard 1140, and each key on the keyboard 1140 is configured with a corresponding conduction unit for connecting the panel touch key on the touch panel module 1120. FIG. 11E illustrates another embodiment of the invention, in which the clip-type controller 1110 is replaced by a knob 1150, and the knob is also configured with a corresponding conduction unit for connecting the panel touch key on the touch panel module 1120, for example, the knob 1150 is used to adjust a sound volume of multimedia.

In summary, the invention provides a touch panel operation apparatus and a method thereof. Objects can be identified according to different frequencies of the simulated finger touch signals, and a same tangible object can be assigned with frequencies of different simulated finger touch signals, so that the tangible object can be identified as different objects along with different frequencies of the simulated finger touch signals. Moreover, only a simple oscillation circuit is used to simulate the finger touch signals without a complicated circuit design, and the static point module made of the conductive material can be used to stably detect the position and rotation angle of the tangible object.

Moreover, by externally connecting a conduction unit without increasing circuits and requiring a power supply, the user can accurately operate the panel touch keys, so as to resolve the problem of the conventional technique that the user's finger probably touches adjacent keys by mistake when pressing a key on the touch panel due to a small screen size of the touch panel. Therefore, the conduction unit that does not increase circuitry and require a power supply is used to transmit the touch signal, and the user can accurately press the panel touch key corresponding to a desired function.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel operation apparatus, comprising:
a controller, generating a simulated finger touch signal on a tangible object; and
a touch panel module, detecting a frequency of the simulated finger touch signal to identify the tangible object.

2. The touch panel operation apparatus as claimed in claim 1, wherein the touch panel module comprises:
a detection unit, detecting the frequency of the simulated finger touch signal;
a database unit, providing object data corresponding to the frequency; and
an identification unit, coupled to the detection unit and the database unit, and identifying the tangible object according to the object data corresponding to the frequency provided by the database unit.

3. A touch panel operation method, comprising:
generating a simulated finger touch signal on a tangible object; and
detecting a frequency of the simulated finger touch signal to identify the tangible object.

4. The touch panel operation method as claimed in claim 3, wherein the step of detecting the frequency of the simulated finger touch signal to identify the tangible object comprises:
detecting the frequency of the simulated finger touch signal;
providing object data corresponding to the frequency; and
identifying the tangible object according to the object data corresponding to the frequency.

5. A touch panel operation method, comprising:
detecting a frequency of a simulated finger touch signal to identify whether a tangible object generating the simulated finger touch signal is a correct unlocking object; and
releasing a locking state of a touch panel module when it is determined that the tangible object is the correct unlocking object.

6. The touch panel operation method as claimed in claim 5, wherein the step of detecting the frequency of the simulated finger touch signal to identify whether the tangible object is the correct unlocking object comprises:
detecting the frequency of the simulated finger touch signal;
providing object data corresponding to the frequency; and
identifying whether the tangible object is the correct unlocking object according to the object data corresponding to the frequency.

7. A touch panel operation apparatus, comprising:
a controller, generating a simulated finger touch signal on a tangible object;
a static point module, disposed at the bottom of the tangible object, and made of a conductive material; and
a touch panel module, detecting a frequency of the simulated finger touch signal and spatial distribution of the static point module to identify the tangible object.

8. The touch panel operation apparatus as claimed in claim 7, wherein the touch panel module detects a moving track of the tangible object to produce a track signal according to electrical conduction between the touch panel module and the static point module, and analyses the track signal to identify a position and a rotation angle of the tangible object.

9. The touch panel operation apparatus as claimed in claim 8, wherein the touch panel module comprises:
a detection unit, detecting the frequency of the simulated finger touch signal, the spatial distribution of the static point module and the track signal;
a database unit, providing object data corresponding to the frequency; and
an identification unit, coupled to the detection unit and the database unit, and identifying the tangible object according to the object data corresponding to the frequency and the spatial distribution of the static point module, and analysing the track signal to identify the position and the rotation angle of the tangible object.

10. A touch panel operation method, comprising:
generating a simulated finger touch signal on a tangible object;
configuring a static point module at the bottom of the tangible object, wherein the static point module is made of a conductive material; and
detecting a frequency of the simulated finger touch signal and spatial distribution of the static point module to identify the tangible object.

11. The touch panel operation method as claimed in claim 10, wherein the step of detecting the frequency of the simulated finger touch signal and the spatial distribution of the static point module to identify the tangible object comprises:
detecting the frequency and the spatial distribution of the static point module;
providing object data corresponding to the frequency and the spatial distribution of the static point module; and
identifying the tangible object according to the object data corresponding to the frequency and the spatial distribution of the static point module.

12. The touch panel operation method as claimed in claim 10, further comprising detecting a moving track of the tangible object to produce a track signal according to electrical conduction between the touch panel module and the static point module, and analysing the track signal to identify a position and a rotation angle of the tangible object.

13. A touch panel operation method, comprising:
detecting a frequency of a simulated finger touch signal and spatial distribution of a static point module to identify whether a tangible object is a correct unlocking object; and
releasing a locking state of a touch panel module when it is determined that the tangible object is the correct unlocking object.

14. The touch panel operation method as claimed in claim 13, wherein the step of detecting the frequency of the simulated finger touch signal and spatial distribution of the static point module to identify whether the tangible object is the correct unlocking object comprises:
detecting the frequency of the simulated finger touch signal and the spatial distribution of the static point module;
providing object data corresponding to the frequency and the spatial distribution of the static point module; and
identifying whether the tangible object is the correct unlocking object according to the object data corresponding to the frequency.

15. A touch panel operation apparatus, comprising:
a touch panel module, detecting whether a panel touch key receives a touch signal, and executing a function corresponding to the panel touch key;
a conduction unit, having a first connection terminal disposed at the panel touch key of the touch panel module; and
a controller, coupled to a second connection terminal of the conduction unit, and transmitting the touch signal generated by the controller to the panel touch key through the conduction unit.

16. A touch panel operation method, comprising:
using a conduction unit to transmit a touch signal of a controller to a panel touch key; and
detecting whether the panel touch key receives the touch signal, and executing a function corresponding to the panel touch key.
